(19) United States
(12) Patent Application Publication
(10) Pub. No.: US 2019/0232224 A1
(43) Pub. Date: Aug. 1, 2019

(54) Engine Exhaust Aftertreatment Incorporating Vanadium-Based SCR

(71) Applicant: International Engine Intellectual Property Company , LLC, Lisle, IL (US)

(72) Inventors: Bradley Jay Adelman, Chicago, IL (US); Matthew R. Smith, Schaumburg, IL (US)

(21) Appl. No.: 15/886,449

(22) Filed: Feb. 1, 2018

(51) Int. Cl. B01D 53/94; F01N 3/20; F01N 13/00; F01N 3/035

(52) U.S. Cl. CPC B01D 53/9418; F01N 3/2073; F01N 13/009; B01D 2255/50; F01N 2610/02; B01D 2255/20723; F01N 3/035

(57) ABSTRACT

A diesel engine has an exhaust aftertreatment system which has a vanadium SCR catalyst for reducing some NOx in engine-out diesel exhaust and a trap for trapping any sublimated vanadium which may be present in exhaust which has been treated by a diesel oxidation catalyst, a diesel particulate filter, and a main SCR catalyst which are between the vanadium SCR catalyst and the trap.

### TECHNICAL FIELD

This disclosure relates to treatment of diesel engine exhaust for preventing certain products of diesel fuel combustion from entering the atmosphere. More particularly, the disclosure relates to a diesel engine exhaust aftertreatment system and a method of diesel engine exhaust aftertreatment which enable a close-coupled vanadium-based SCR catalyst to be used in conjunction with a diesel oxidation catalyst and a diesel particulate filter for improved aftertreatment of diesel engine exhaust.

### BACKGROUND

One technology for aftertreatment of diesel engine exhaust utilizes selective catalytic reduction (SCR) to enable known chemical reactions which convert NOx into nitrogen (N₂) and water (H₂O), two constituents found in abundance in earth's atmosphere. A reaction may involve only ammonia (NH₃) stored on surface sites of certain types of SCR catalysts and NOx in the exhaust, or a reaction may involve those two reactants and an additional reactant, oxygen (O₂), if the latter is also present in the exhaust.

Ammonia which is used in those reactions is created by chemical reactions involving diesel exhaust fluid (DEF), an aqueous mixture of urea and deionized water, which is injected into the aftertreatment system. When DEF is injected into engine exhaust, thermal energy of the exhaust causes the water component to vaporize and the urea component to decompose. One of the products of urea decomposition is NH₃ whose molecules attach to catalytic sites on washcoat surfaces of certain types of SCR catalysts and are available to reduce NOx in exhaust passing across those surfaces by chemical conversion to N₂ and H₂O.

At the present time, diesel engine powered road vehicles manufactured for use in North America have engine exhaust aftertreatment systems which use SCR catalysts containing certain types of catalytic material, such as copper zeolite or iron zeolite (metal-exchanged zeolites), for NOx emission control. While those catalytic materials are generally more costly than other catalytic material, such as vanadium-based material, they, unlike a vanadium-based material, possess better thermal stability. However, because copper zeolite and iron zeolite, when used as catalytic material, have potential to promote formation of N₂O, that possibility is taken into account in an emission-compliant NOx control strategy by imposing a limit on engine-out NOx. However, limiting engine-out NOx limits fuel efficiency of an engine.

Vanadium-based material has been widely and extensively used for meeting emission compliance criteria by selective catalytic reduction of certain constituents in gases created by industrial processes in stationary applications such as electric utilities and manufacturing plants where the operation of process equipment, unlike operation of a diesel engine in a motor vehicle, is fairly stable and vanadium-based material is tolerable to typical industrial gas temperatures. Vanadium-based material has been also used to a limited extent in mobile applications. For example, certain diesel engine powered vehicles manufactured for use in Europe have been using vanadium-based SCR catalysts in their exhaust aftertreatment systems for meeting applicable European NOx emission compliance standards. However, those uses of vanadium-based material occur in aftertreatment systems which differ from North American vehicle systems because they operate at temperatures below the sublimation temperature of vanadium-based material.

In North American highway vehicles which are powered by diesel engines, an SCR catalyst has been used in conjunction with a diesel oxidation catalyst (DOC) and a diesel particulate filter (DPF). A DOC treats diesel engine exhaust by removing certain entrained matter, such as the soluble organic fraction of diesel particulate matter. A DPF removes entrained soot from the diesel engine exhaust.

Because a DPF must occasionally be purged of trapped soot to remain effective in trapping soot, it undergoes a regeneration cycle once the quantity of trapped soot exceeds some threshold. Therefore several types of regeneration, which go by different names, may involve different modalities. In general however, they all function to incinerate trapped soot by significant temperature elevation for limited periods of time.

When a DPF is located upstream of an SCR catalyst in an exhaust aftertreatment system, as it typically is, flow through the aftertreatment system carries the heat of incineration downstream to the SCR catalyst, elevating the latter's temperature. Temperatures of the SCR catalyst can rise significantly, and consequently use of catalytic materials which can withstand the elevated temperatures caused by repeatedly occurring DPF regeneration cycles is essential in such an aftertreatment system in order to comply with applicable emission criteria and with a manufacturer's warranty.

### SUMMARY OF THE DISCLOSURE

Recognizing that vanadium-based material may not be an acceptable alternative to copper zeolite and iron zeolite when such regeneration cycles will be repeatedly occurring, the inventors are presenting in this disclosure a diesel engine exhaust aftertreatment system which incorporates a vanadium-based catalyst in conjunction with a DPF and a DOC in such a way that sublimation temperature of the vanadium-based material is not exceeded, even during DPF regeneration cycles. By locating a vanadium-based catalyst upstream of the DPF, the vanadium-based catalyst is not directly heated by heat resulting from incineration of soot trapped by the DPF.

Using only a zeolite catalyst in a strategy for meeting both a fuel economy objective and compliance with applicable emission criteria may require an engine at times to operate so lean of stoichiometric that the resulting increase in engine-out NOx could be sufficiently great that a non-compliant quantity of N₂O in tailpipe-out exhaust is generated.

The exemplary embodiment of aftertreatment system to be described in detail hereinafter places a vanadium-based catalyst which is used in a first step of the disclosed method in “close-coupled” relationship with an engine exhaust manifold, meaning that the vanadium-based catalyst treats “engine-out” diesel exhaust. In a turbocharged diesel engine, engine-out diesel exhaust is used to operate a turbocharger and the “close-coupling” occurs through the turbocharger turbine, as described in the disclosed embodiment. DEF is metered to entrain with engine-out exhaust so that as the flow moves across surfaces of the vanadium-based catalyst, catalytic action between NOx and ammonia reduces NOx in sufficient quantity before the flow reaches a downstream metal zeolite catalyst to avoid excessive generation of N₂O.

While one attribute of a diesel engine is that it runs relatively cool in comparison to a spark-ignited gasoline engine, engine-out temperature of engine-out diesel exhaust may occasionally temporarily cause sublimation of some vanadium-based material and ensuing entrainment of that material in the exhaust flow. There are different species of vanadium-based catalytic material, one of which is vanadia (V₂O₅) which when exposed to temperatures in excess of 550° C., begins to irreversibly degrade by sublimation. High surface area support material (such as TiO₂ in the anatase phase) for the catalytic material undergoes a phase change (to rutile) at such elevated temperatures, causing the vanadia to sinter and sublimate.

Before the exhaust flow exits the aftertreatment system, it must pass thorough a trap. The trap guards against unintended sublimation of vanadia and acts to condense any sublimated vanadia which may be present in the exhaust, and to trap the condensate so that it does not escape into surrounding atmosphere.

A general aspect of the claimed subject matter relates to a method for aftertreatment of diesel engine exhaust flowing through aftertreatment flow path having an entrance through which untreated engine-out diesel exhaust enters and an exit through which treated diesel exhaust exits to surrounding atmosphere.

The method comprises: 1) catalytically reducing some NOx in engine-out diesel exhaust flow across vanadium-based catalytic material on surfaces of a vanadium-based SCR catalyst by injecting diesel exhaust fluid (DEF) to entrain with engine-out diesel exhaust flow, 2) using a diesel oxidation catalyst (DOC) to treat exhaust flow from the vanadium-based SCR catalyst, 3) using a diesel particulate filter (DPF) to treat exhaust flow from the DOC, 4) catalytically reducing some NOx in exhaust flow from the DPF across catalytic surfaces of a main SCR catalyst by injecting DEF to entrain with exhaust flow from the DPF and 5) using a vanadium trap through which exhaust from the main SCR catalyst flows to condense sublimated vanadium-based catalytic material which may be present in the exhaust flow through the trap and to trap the condensate to prevent escape of vanadium-based catalytic material into the surrounding atmosphere.

Another general aspect of the claimed subject matter relates to a motor vehicle powered by a diesel engine which has an exhaust aftertreatment system for performing the method.

Still another general aspect of the claimed subject matter relates to an exhaust aftertreatment system for performing the method.

The foregoing summary is accompanied by further detail of the disclosure presented in the Detailed Description below with reference to the following drawings which are part of the disclosure.

### BRIEF DESCRIPTION OF THE DRAWINGS

FIG. 1 shows a highway vehicle having a diesel engine and diesel engine exhaust aftertreatment system.

FIG. 2 is a general schematic diagram of the engine and aftertreatment system of FIG. 1.

FIG. 3 is a schematic diagram showing more detail of the aftertreatment system.

FIG. 4 schematically generally illustrates a vanadium trapping component of the aftertreatment system.

FIG. 5 is a first and more detailed example of the vanadium trapping component of FIG. 4.

FIG. 6 is a second and more detailed example of the vanadium trapping component of FIG. 4.

FIG. 7 is a third example of a vanadium trapping component.

### DETAILED DESCRIPTION

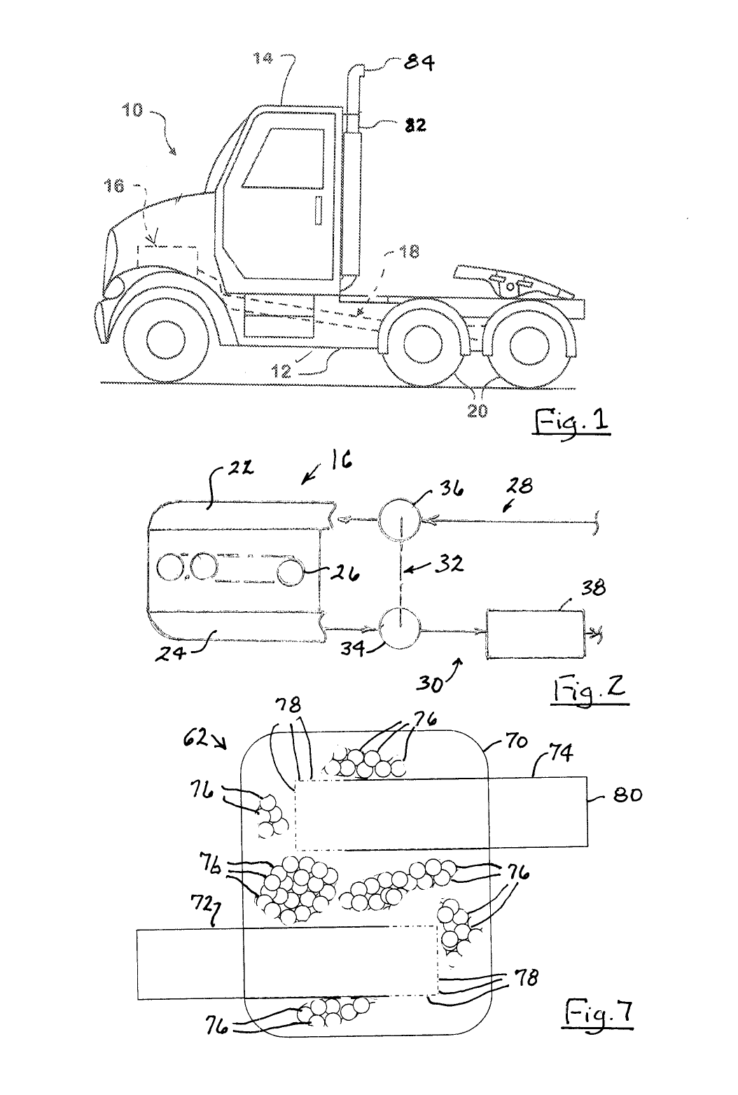

FIG. 1 shows a highway tractor 10 having a chassis 12 and a cab body 14 supported on a frame of chassis 12. A turbocharged diesel engine 16 is also supported on the frame and operates through a drivetrain 18 to drive rear wheels 20 which propel highway tractor 10 on an underlying road surface.

While the exhaust aftertreatment system which is disclosed here can be applied to various diesel engine configurations, the configuration in the example of engine 16 which is shown in FIG. 2 is an in-line configuration which has a single intake manifold 22, a single exhaust manifold 24, and a number of in-line engine cylinders 26. Air is conveyed through an intake system 28 to intake manifold 22 from which air enters individual engine cylinders 26 when a respective cylinder's intake valve (or intake valves in the case of a multi-valve engine) opens during an engine cycle. Diesel fuel is injected into a respective engine cylinder 26 after its intake valve has closed, with the injected fuel combusting with air which has been compressed in the cylinder. When a respective cylinder exhaust valve (or exhaust valves in the case of a multi-valve engine) opens, products of combustion exit the engine cylinder to pass through exhaust manifold 24 before entering and passing through an exhaust system 30 to atmosphere.

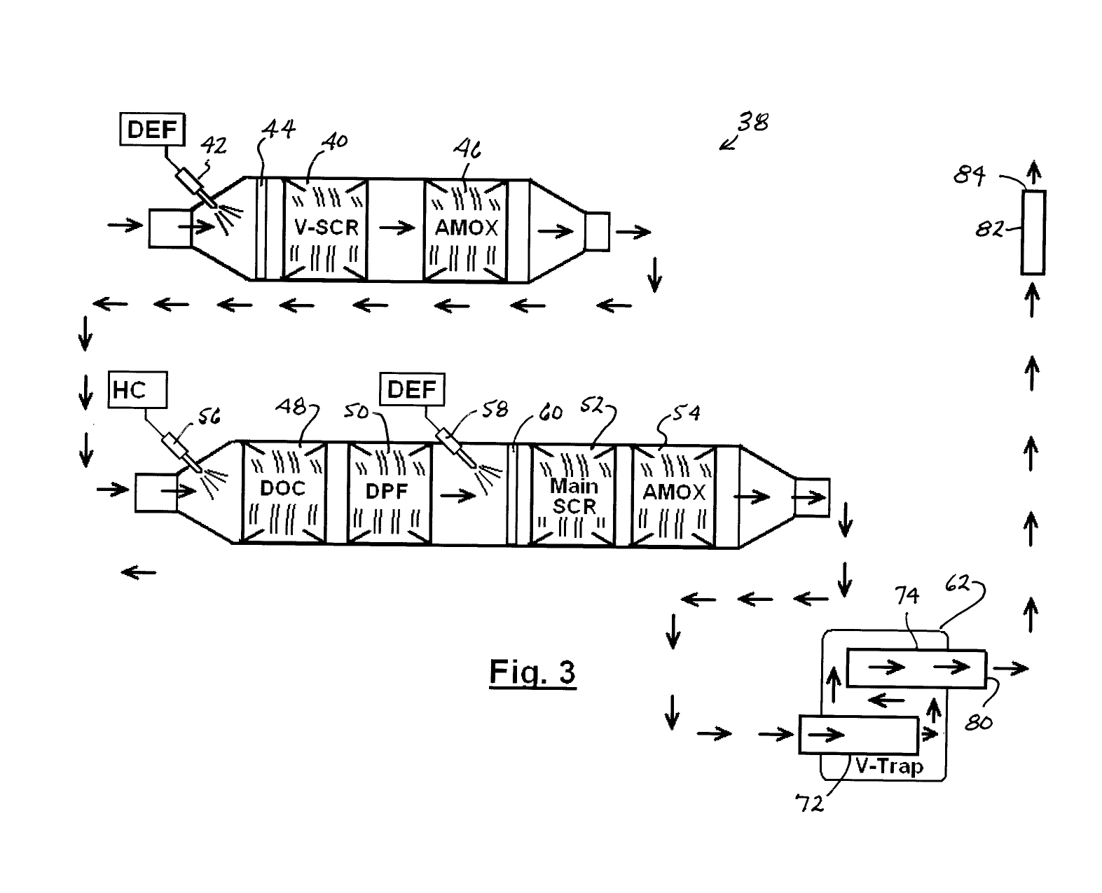

FIG. 2 also shows a turbocharger 32 having a turbine 34 which is operated by thermal energy of combusted diesel fuel coming from exhaust manifold 24 (i.e. by engine-out exhaust). Turbine 34 operates a compressor 36 in intake system 28 to create charge air which ultimately is combusted in engine cylinders 26. After passing through turbine 34, exhaust enters an entrance of an exhaust aftertreatment system 38 which is shown in detail in FIG. 3 where the direction of exhaust flow is indicated by the arrows.

Exhaust aftertreatment system 38 comprises a vanadium-based SCR catalyst 40 through which engine-out exhaust is constrained to pass after leaving turbine 34. Vanadium-based SCR catalyst 40 is mounted on engine 16 near the turbocharger's outlet and comprises a substrate on surfaces of which vanadium-based catalytic material is disposed. Selective catalytic reduction of some NOx in engine-out exhaust is performed by the catalytic action of vanadium-based SCR catalyst 40 which enables certain chemical reactions between NOx and ammonia which is derived from diesel exhaust fluid (DEF) which is injected by a DEF injector 42 to entrain with the exhaust flow. There are different species of vanadium-based catalytic material, for example, vanadia which is dispersed on underlying structure of SCR catalyst 40. A static mixer 44 may be placed between DEF injector 42 and vanadium-based SCR catalyst 40 to promote wide distribution of DEF within the engine-out exhaust.

DEF is an aqueous urea solution comprising urea and water, a commercial example being a solution of 32.5% urea and 67.5% deionized water. DEF for use in aftertreatment system 38 is stored in a storage tank on-board highway tractor 10 and is supplied to DEF injector 42 by a delivery system which includes a controller for controlling quantity of DEF being injected into the exhaust flow. Thermal energy in the engine-out exhaust vaporizes the water component and decomposes the urea component of the injected DEF according to known chemical reactions to create free ammonia molecules for reducing NOx by known chemical reactions.

4NO+4NH₃+O₂→4N₂+6H₂O

NO+NO₂+2NH₃→2N₂+3H₂O

6NO₂+8NH₃→7N₂+12H₂O

An ammonia slip (AMOX) catalyst 46 may be placed after vanadium-based SCR catalyst 40 to convert any ammonia leaving the latter into nitrogen and water vapor.

After leaving vanadium-based SCR catalyst 40, the exhaust flow is constrained to pass in succession across surfaces of a diesel oxidation catalyst (DOC) 48, through a diesel particulate filter (DPF) 50, across surfaces of a main SCR catalyst 52 and surfaces of an ammonia slip catalyst 54. DOC 48 treats engine exhaust by removing certain entrained matter, such as the soluble organic fraction of diesel particulate matter. DPF 50 removes entrained soot from the exhaust. If exhaust temperature needs elevation for burning off trapped soot, combustible hydrocarbons may be introduced into the exhaust ahead of DOC 48 via a fuel injector 56. Diesel fuel is of course readily available from a fuel tank of highway tractor vehicle 10 and is commonly injected through DEF injector 56. Main SCR catalyst 52 treats engine exhaust by reducing NOx according to chemical reactions mentioned above. Ammonia slip catalyst 54 is placed after main SCR catalyst 52 to convert any ammonia leaving the latter into nitrogen and water vapor. Heat generated by combustion of hydrocarbons injected into the exhaust can also remove deposits caused by DEF injection as well as substances like sulfur and other hydrocarbons that have been collected on main SCR catalyst 52.

DOC 48, DPF 50, main SCR catalyst 52, and ammonia slip catalyst 54 are contained inside a common housing mounted on a frame rail of chassis 12 or inside multiple housings connected by pipes. Piping conveys the exhaust flow from vanadium-based SCR catalyst 40 to an inlet of a housing containing DOC 48.

A DEF injector 58 injects DEF from the on-board DEF storage tank into the exhaust flow as the flow approaches main SCR catalyst 52. A static mixer 60 may be placed between DEF injector 58 and main SCR catalyst 52 to promote wide distribution of DEF within the exhaust flow. While any catalytic material which can withstand whatever DPF regeneration temperatures main SCR catalyst may be subjected to during DPF regenerations, iron zeolite and copper zeolite are examples of catalyst materials suitable for main SCR catalyst 52. Thermal energy in the exhaust flow vaporizes the DEF water component and decomposes the DEF urea component to create free ammonia molecules which attach to catalytic surface sites of main SCR catalyst 52 when a metal-exchanged zeolite is used. A controller has a control strategy which controls quantity of DEF which DEF injector 58 injects. Control may be performed by processing measurements from NOx sensors (not shown) to calculate NOx reduction quantity and controlling quantity of injected DEF so that calculated NOx reduction quantity meets a NOx reduction quantity target which provides compliance with applicable NOx emission criteria.

FIG. 3 further shows a vanadia trap 62 through which exhaust coming from ammonia slip catalyst is constrained to pass. Vanadia trap 62 provides a sufficiently large surface area of material capable of trapping sublimated vanadia. Alumina is an example of suitable trapping material. The trapping material can be entirely alumina or alumina deposited as a washcoat on a material other than alumina. Condensed vanadia is trapped by chemical bonding to alumina.

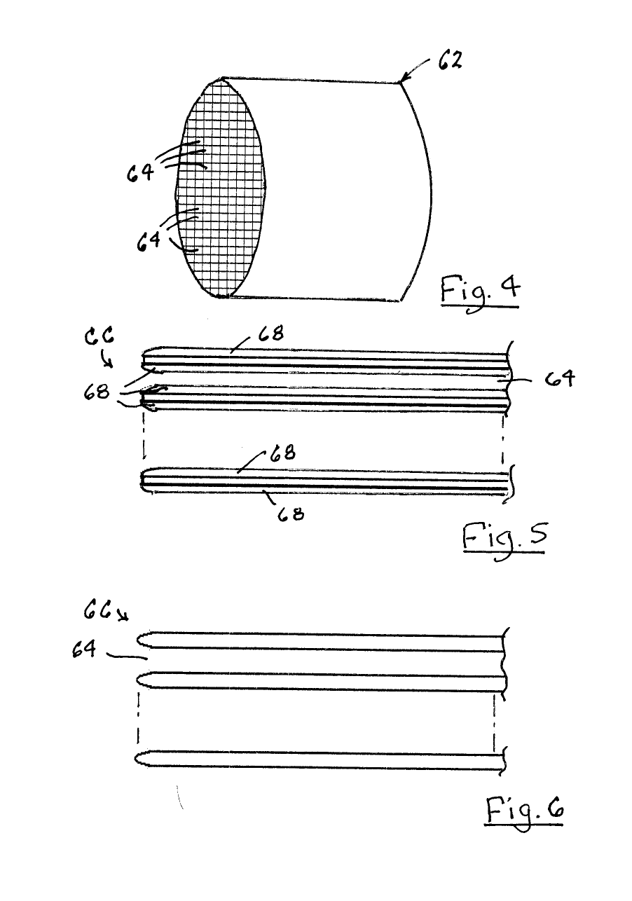

The physical construction of trap 62 can assume various forms, examples of which are shown in FIGS. 4-7. FIG. 4 is generic to FIGS. 5 and 6 for showing trap 62 to comprise multiple channels 64 through which exhaust can flow.

A first construction shown in FIG. 5 comprises a latticework structure 66 forming multiple parallel flow channels 64 onto whose surfaces a coating of alumina 68 has been adhered. The latticework may be a ceramic.

A second construction shown in FIG. 6 also comprises a latticework structure of similar geometry but differing from FIG. 5 in that the latticework itself is constructed of alumina which has been extruded to form a monolithic structure containing channels 64.

The trap of FIG. 7 comprises a walled enclosure 70 having an inlet pipe 72 and an outlet pipe 74 which penetrate the enclosure wall. The pipes are not aligned with each other and extend far enough inside to overlap and place their respective outlet and inlet ends close to opposite sides of the enclosure wall. Enclosure 70 contains a fill of pellets 76, which may be ceramic beads individually coated with alumina. The outlet of inlet pipe 72 and the inlet of outlet pipe 74 have multiple orifices 78 in sufficient number for allowing exhaust to pass into and out of enclosure 70 without significant restriction. The orifices are sufficiently smaller in size than pellets 76 to prevent escape of pellets from enclosure 70. The pellets are also packed tightly to prevent their movement within the enclosure but they are sized to leave voids through which exhaust can disperse throughout the enclosure without any significant restriction to flow from the outlet of inlet pipe 72 to the inlet of outlet pipe 74. In that way the pellets provide substantial alumina surface area for trapping vanadia as exhaust flows through the enclosure. Outlet pipe 74 has an outlet 80 through which treated exhaust passes to and through a tailpipe 82 (FIG. 1) to an exit 84 into surrounding atmosphere.

By locating trap 62 in the exhaust flow path sufficiently downstream from main SCR catalyst 52, the temperature of the trapping material is sufficiently low to assure condensation and trapping of sublimated vanadia. The schematic showing of the aftertreatment components as separate components should not necessarily be construed to imply that they must be separate components. For example an ammonia slip catalyst and an SCR catalyst may be zone-coated onto different zones of a common substrate.

What is claimed is:

1. A motor vehicle comprising a diesel engine for propelling the vehicle, the diesel engine comprising an exhaust system forming an exhaust flow path having an entrance through which engine-out diesel exhaust enters and an exit through which treated diesel exhaust exits to surrounding atmosphere, the exhaust flow path containing: 1) a vanadium-based SCR catalyst having surfaces containing vanadium-based catalytic material across which engine-out diesel exhaust flows, and a diesel exhaust fluid (DEF) injector for injecting DEF to entrain with engine-out diesel exhaust flow for enabling catalytic reduction of some NOx in engine-out diesel exhaust flow across the vanadium-based catalytic material, 2) a diesel oxidation catalyst (DOC) for treating exhaust flow from the vanadium-based SCR catalyst, 3) a diesel particulate filter (DPF) for treating exhaust flow from the DOC, 4) a main SCR catalyst having surfaces containing catalytic material across which exhaust treated by the DPF flows, and a diesel exhaust fluid (DEF) injector for injecting DEF to entrain with exhaust flow from the DPF for enabling catalytic reduction of some NOx in exhaust flow across the catalytic material of the main SCR catalyst, and 5) a vanadium trap through which exhaust flow from the main catalyst flows for condensing sublimated vanadium-based catalytic material which may be present in the exhaust flow and trapping the condensate to prevent escape of vanadium-based catalytic material into surrounding atmosphere.

2. The motor vehicle as set forth in claim 1 in which the vanadium-based catalytic material comprises vanadia which is dispersed on underlying structure of the vanadium-based SCR catalyst.

3. The motor vehicle as set forth in claim 1 further comprising a turbine of a turbocharger in the exhaust flow path upstream of the vanadium-based SCR catalyst, and an ammonia slip catalyst for converting ammonia which has passed through at least one of the SCR catalysts, by chemical reactions, into nitrogen and water.

4. The motor vehicle as set forth in claim 3 in which the vanadium-based SCR catalyst is mounted on the engine, the motor vehicle comprises a chassis having a frame, and the DOC, the DPF, and the main SCR catalyst are mounted on the frame.

5. The motor vehicle as set forth in claim 1 in which the catalytic material of the main SCR catalyst comprises a metal-exchanged zeolite.

6. The motor vehicle as set forth in claim 1 in which the vanadium trap comprises alumina for trapping the condensate by chemical bonding.

7. The motor vehicle as set forth in claim 6 in which the vanadium trap comprises an enclosure within which is disposed a structure comprising multiple exhaust flow channels, each channel having an alumina surface across which exhaust flows.

8. The motor vehicle as set forth in claim 6 in which the vanadium trap comprises an enclosure containing packed alumina-coated pellets leaving voids through which exhaust can disperse throughout the enclosure.

9. A diesel engine exhaust aftertreatment system comprising an exhaust flow path having an entrance through which engine-out diesel exhaust enters and an exit through which treated diesel exhaust exits to surrounding atmosphere, the exhaust flow path comprising:
1) a vanadium-based SCR catalyst having surfaces containing vanadium-based catalytic material across which engine-out diesel exhaust flows, and a diesel exhaust fluid (DEF) injector for injecting DEF to entrain with engine-out diesel exhaust flow for enabling catalytic reduction of some NOx in engine-out diesel exhaust flow across the vanadium-based catalytic material, 2) a diesel oxidation catalyst (DOC) for treating exhaust flow from the vanadium-based SCR catalyst, 3) a diesel particulate filter (DPF) for treating exhaust flow from the DOC, 4) a main SCR catalyst having surfaces containing catalytic material across which exhaust treated by the DPF flows, and a diesel exhaust fluid (DEF) injector for injecting DEF to entrain with exhaust flow from the DPF for enabling catalytic reduction of some NOx in exhaust flow across the catalytic material of the main SCR catalyst, and 5) a vanadium trap through which exhaust flow from the main SCR catalyst flows for condensing sublimated vanadium-based catalytic material which may be present in the exhaust flow and trapping the condensate to prevent escape of vanadium-based catalytic material into surrounding atmosphere.

10. The diesel engine exhaust aftertreatment system as set forth in claim 9 in which the vanadium-based catalytic material comprises vanadia which is dispersed on underlying structure of the vanadium-based SCR catalyst.

11. The diesel engine exhaust aftertreatment system as set forth in claim 9 in which the catalytic material of the main SCR catalyst comprises a metal-exchanged zeolite.

12. The diesel engine exhaust aftertreatment system as set forth in claim 9 in which the vanadium trap comprises alumina for trapping the condensate by chemical bonding.

13. The diesel engine exhaust aftertreatment system as set forth in claim 12 in which the vanadium trap comprises an enclosure within which is disposed a structure comprising multiple exhaust flow channels, each channel having an alumina surface across which exhaust flows.

14. The diesel engine exhaust aftertreatment system as set forth in claim 12 in which the vanadium trap comprises an enclosure containing packed alumina-coated pellets leaving voids through which exhaust can disperse throughout the enclosure.

15. A method for aftertreatment of diesel engine exhaust flowing through aftertreatment flow path having an entrance through which untreated engine-out diesel exhaust enters and an exit through which treated diesel exhaust exits to surrounding atmosphere, the method comprising:
1) catalytically reducing some NOx in engine-out diesel exhaust flow across vanadium-based catalytic material on surfaces of a vanadium-based SCR catalyst by injecting diesel exhaust fluid (DEF) to entrain with engine-out diesel exhaust flow, 2) using a diesel oxidation catalyst (DOC) to treat exhaust flow from the vanadium-based SCR catalyst, 3) using a diesel particulate filter (DPF) to treat exhaust flow from the DOC, 4) catalytically reducing some NOx in exhaust flow from the DPF across catalytic surfaces of a main SCR catalyst by injecting DEF to entrain with exhaust flow from the DPF and 5) using a vanadium trap through which exhaust from the main SCR catalyst flows to condense sublimated vanadium-based catalytic material which may be present in the exhaust flow through the trap and to trap the condensate to prevent escape of vanadium-based catalytic material into surrounding atmosphere.

16. The method as set forth in claim 15 in which catalytically reducing some NOx in engine-out exhaust flow across vanadium-based catalytic material on surfaces of a vanadium-based SCR catalyst comprises catalytically reducing some NOx in engine-out exhaust flow across vanadia on surfaces of the vanadium-based SCR catalyst.

17. The method as set forth in claim 15 in which catalytically reducing some NOx in exhaust flow across catalytic material on surfaces of a main SCR catalyst comprises catalytically reducing some NOx in exhaust flow across a metal-exchanged zeolite on surfaces of the main SCR catalyst.

18. The method as set forth in claim 15 in which using a vanadium trap through which exhaust from the mainmain SCR catalyst flows to condense sublimated vanadium-based catalytic material in the exhaust flow through the trap and to trap the condensate comprises trapping condensate by bonding condensate to alumina disposed within an enclosure through which exhaust flows.

19. The method as set forth in claim 18 in which bonding condensate to alumina comprises bonding condensate to alumina-coated pellets packed within the enclosure.

20. The method as set forth in claim 18 in which bonding condensate to alumina comprises bonding condensate to alumina surfaces of exhaust flow channels within the enclosure.
